(19) United States
(12) Patent Application Publication
(10) Pub. No.: US 2022/0162457 A1
(43) Pub. Date: May 26, 2022

(54) AUTOMOTIVE COATINGS WITH NON-SPHERICAL PHOTONIC STRUCTURAL COLORANTS

(71) Applicant: BASF COATINGS GMBH, Münster (DE)

(72) Inventors: Zenon Paul CZORNIJ, Southfield, MI (US); Charles L. TAZZIA, Wyandotte, MI (US); Paragkumar THANKI, Mangalore (IN)

(21) Appl. No.: 17/438,124

(22) PCT Filed: Mar. 11, 2020
(86) PCT No.: PCT/US20/22159

§ 371 Date: Sep. 10, 2021

(51) Int. Cl. C09D 5/36; C09D 7/62; C09D 7/40; C09D 125/06; C09D 133/12

(52) U.S. Cl. CPC C09D 5/36; C09D 7/62; C09D 133/12; C09D 7/70; C09D 125/06; C09D 7/69

(57) ABSTRACT

Disclosed in certain embodiments is coating composition comprising a solvent, a resinous binder, and a structural colorant comprising non-spherical photonic structures, and corresponding coatings, coated automotive parts, and methods involving the same.

### CROSS-REFERENCE TO RELATED APPLICATION(S)

This application claims the benefit of priority of U.S. Provisional Patent Application No. 62/817,200, filed on Mar. 12, 2019, the disclosure of which is hereby incorporated by reference herein in its entirety.

### TECHNICAL FIELD

Disclosed are automotive coatings that include a structural colorant in the form of non-spherical photonic structures as well as coating compositions and methods thereof.

### BACKGROUND

Traditional pigments and dyes exhibit color via light absorption and reflection, relying on chemical structure. Structural colorants exhibit color via light interference effects, relying on physical structure as opposed to chemical structure. Structural colorants are found in nature, for instance in bird feathers, butterfly wings and certain gemstones. Structural colorants are materials containing microscopically structured surfaces small enough to interfere with visible light and produce color.

Structural colorants can be manufactured to provide color in various goods such as paints and automotive coatings. For manufactured structural colorants, it is desired that the material exhibit high chromatic values, special photonic effects, dimensions allowing their use in particular applications, and chemical and thermal robustness. The robustness of the material is important in order to allow their in-process stability in paint systems and under various natural weathering conditions.

There exists a continued need in the art for automotive coatings that include structural colorant that provides a diverse range of robust colors.

### OBJECTS AND SUMMARY OF THE INVENTION

It is an object of certain embodiments of the present invention to provide an automotive coating composition that includes a structural colorant comprising non-spherical photonic structures.

It is another object of certain embodiments of the present invention to provide a method of preparing an automotive coating composition that includes a structural colorant comprising non-spherical photonic structures.

It is a further object of certain embodiments of the present invention to provide an automotive coating that includes a structural colorant comprising non-spherical photonic structures.

It is a further object of certain embodiments of the present invention to provide a manufactured automotive article that has a substrate and a coating that includes a structural colorant comprising non-spherical photonic structures.

One or more of the above objects and others can be achieved by virtue of the present invention which in certain embodiments is directed to a coating composition comprising (i) a solvent, (ii) a resinous binder and (iii) a structural colorant comprising non-spherical photonic structures. In certain embodiments, the coating composition provides a coating that exhibits an L* value from 15 degree angle to 110 degree angle from specular reflection that does not change by more than about 50%, by more than about 35% or by more than about 25%.

In some embodiments, the coating composition provides a coating that exhibits an L* value from 15 degree angle to 110 degree angle from specular reflection that does not change by more than about 50%, by more than about 35% or by more than about 25%.

In some embodiments, the coating composition provides a coating that exhibits an L* value that increases from 15 degree angle to 110 degree angle from specular reflection.

In some embodiments, the coating composition provides a coating that exhibits an L* value from 15 degree angle to 110 degree angle from specular reflection that changes more than about 3 units, more than about 5 units or more than about 10 units.

In some embodiments, the coating composition provides a coating that exhibits an L* value from 15 degree angle to 110 degree angle from specular reflection that changes less than about 25 units, less than about 15 units or less than about 10 units.

In some embodiments, the coating composition provides a coating that exhibits a C* value from 15 degree angle to 110 degree angle from specular reflection that does not change by more than about 50%, by more than about 35% or by more than about 25%.

In some embodiments, the coating composition provides a coating that exhibits a C* value that decreases from 15 degree angle to 110 degree angle from specular reflection.

In some embodiments, the coating composition provides a coating that exhibits a C* value from 15 degree angle to 110 degree angle from specular reflection that changes more than about 3 units, more than about 5 units or more than about 10 units.

In some embodiments, the coating composition provides a coating that exhibits a C* value from 15 degree angle to 110 degree angle from specular reflection that changes less than about 25 units, less than about 15 units or less than about 10 units.

In some embodiments, the coating composition provides a coating that exhibits an h value from 15 degree angle to 110 degree angle from specular reflection that does not change by more than about 75%, by more than about 50%, by more than about 25% or by more than about 10%.

In some embodiments, the coating composition provides a coating that provides a coating that exhibits an h value that decreases from 15 degree angle to 110 degree angle from specular reflection.

In some embodiments, the coating composition provides a coating that provides a coating that exhibits an h value from 15 degree angle to 110 degree angle from specular reflection that changes more than about 25 units, more than about 50 units or more than about 100 units.

In some embodiments, the coating composition provides a coating that exhibits an h value from 15 degree angle to 110 degree angle from specular reflection that changes less than about 200 units, less than about 150 units or less than about 100 units.

In some embodiments, the coating composition provides a coating that exhibits an a* value from 15 degree angle to 110 degree angle from specular reflection that does not change by more than about 10 units, by more than about 5 units or more than about 2 units.

In some embodiments, the coating composition provides a coating that exhibits a b* value from 15 degree angle to 110 degree angle from specular reflection that does not change by more than about 25 units, by more than about 15 units or more than about 10 units.

Other embodiments are directed to a coating comprising a resinous binder and a structural colorant comprising non-spherical photonic structures. In certain embodiments, the coating exhibits an L* value from 15 degree angle to 110 degree angle from specular reflection that does not change by more than about 50%, by more than about 35% or by more than about 25%.

In some embodiments, the coating exhibits an L* value that increases from 15 degree angle to 110 degree angle from specular reflection.

In some embodiments, the coating exhibits an L* value from 15 degree angle to 110 degree angle from specular reflection that changes more than about 3 units, more than about 5 units or more than about 10 units.

In some embodiments, the coating exhibits an L* value from 15 degree angle to 110 degree angle from specular reflection that changes less than about 25 units, less than about 15 units or less than about 10 units.

In some embodiments, the coating exhibits a C* value from 15 degree angle to 110 degree angle from specular reflection that does not change by more than about 50%, by more than about 35% or by more than about 25%.

In some embodiments, the coating exhibits a C* value that decreases from 15 degree angle to 110 degree angle from specular reflection.

In some embodiments, the coating exhibits a C* value from 15 degree angle to 110 degree angle from specular reflection that changes more than about 3 units, more than about 5 units or more than about 10 units.

In some embodiments, the coating exhibits a C* value from 15 degree angle to 110 degree angle from specular reflection that changes less than about 25 units, less than about 15 units or less than about 10 units.

In some embodiments, the coating exhibits an h value from 15 degree angle to 110 degree angle from specular reflection that does not change by more than about 75%, by more than about 50%, by more than about 25%, or by more than about 10%.

In some embodiments, the coating exhibits an h value that decreases from 15 degree angle to 110 degree angle from specular reflection.

In some embodiments, the coating exhibits an h value from 15 degree angle to 110 degree angle from specular reflection that changes more than about 25 units, more than about 50 units or more than about 100 units.

In some embodiments, the coating exhibits an h value from 15 degree angle to 110 degree angle from specular reflection that changes less than about 200 units, less than about 150 units or less than about 100 units.

In some embodiments, the coating exhibits an a* value from 15 degree angle to 110 degree angle from specular reflection that does not change by more than about 10 units, by more than about 5 units or more than about 2 units.

In some embodiments, the coating exhibits a b* value from 15 degree angle to 110 degree angle from specular reflection that does not change by more than about 25 units, by more than about 15 units or more than about 10 units.

The non-spherical structural colorants according to any of the embodiments disclosed herein can be, e.g., selected from the group consisting of photonic crystals, photonic granules, opals, inverse opals, folded photonic structures and platelet-like photonic structures. In a particular embodiment, the non-spherical structural colorant is platelet-like.

Further embodiments are directed to automotive parts comprising the coatings disclosed herein and methods thereof.

### BRIEF DESCRIPTION OF THE DRAWINGS

The disclosure described herein is illustrated by way of example and not by way of limitation in the accompanying figures.

FIG. 1 depicts coloristic properties of an inventive example for 5 angles.

FIG. 2 depicts coloristic properties of an inventive example for 3 angles.

FIG. 3 depicts reflectance curves for 5 angles for an inventive example and control

FIG. 4 depicts reflectance curves for 5 angles for an inventive example and control

FIG. 5 depicts sparkle area and intensity data for an inventive example and control.

### DETAILED DESCRIPTION

In certain embodiments, the invention is directed to a coating composition comprising (i) a solvent, (ii) a resinous binder and (iii) a structural colorant comprising non-spherical photonic structures.

Certain embodiments are directed to coatings derived from the coating compositions disclosed herein.

Certain embodiments are directed to a coating comprising a colorant layer comprising a (i) a resinous binder and (ii) a structural colorant comprising non-spherical photonic structures.

In certain embodiments, the coating further comprises a ground coat, wherein the colorant layer is layered over the ground coat. The ground coat can be, e.g., black.

Certain embodiments further comprise a clear coat layer, wherein the clear coat is layered over the colorant layer.

Certain embodiments further comprise one or more additional layers (i) between the ground layer and the colorant layer, (ii) between the colorant layer and the clear coat layer, (iii) over the clear coat layer, (iv) under the ground layer, or a combination thereof. The structural colorant can be included in one or more of the ground, layer, the colorant layer, the clear coat layer or any of the additional layers.

In certain embodiments disclosed herein, the coating exhibits, e.g., an L* value from 15 degree angle to 110 degree angle from specular reflection that does not change by more than about 50%, by more than about 35% or by more than about 25%.

In other embodiments, the coating exhibits, e.g., an L* value that increases from 15 degree angle to 110 degree angle from specular reflection.

In further embodiments, the coating exhibits, e.g., an L* value from 15 degree angle to 110 degree angle from specular reflection that changes more than about 3 units, more than about 5 units or more than about 10 units.

In other embodiments, the coating exhibits, e.g., an L* value from 15 degree angle to 110 degree angle from specular reflection that changes less than about 25 units, less than about 15 units or less than about 10 units.

In further embodiments, the coating exhibits, e.g., a C* value from 15 degree angle to 110 degree angle from specular reflection that does not change by more than about 50%, by more than about 35% or by more than about 25%.

In other embodiments, the coating exhibits, e.g., a C* value that decreases from 15 degree angle to 110 degree angle from specular reflection.

In further embodiments, the coating exhibits, e.g., a C* value from 15 degree angle to 110 degree angle from specular reflection that changes more than about 3 units, more than about 5 units or more than about 10 units.

In other embodiments the coating exhibits, e.g., a C* value from 15 degree angle to 110 degree angle from specular reflection that changes less than about 25 units, less than about 15 units or less than about 10 units.

In further embodiments, the coating exhibits, e.g., an h value from 15 degree angle to 110 degree angle from specular reflection that does not change by more than about 75%, by more than about 50%, by more than about 25% or by more than about 10%.

In other embodiments, the coating exhibits, e.g., an h value that decreases from 15 degree angle to 110 degree angle from specular reflection.

In further embodiments, the coating exhibits, e.g., an h value from 15 degree angle to 110 degree angle from specular reflection that changes more than about 25 units, more than about 50 units or more than about 100 units.

In other embodiments, the coating exhibits, e.g., an h value from 15 degree angle to 110 degree angle from specular reflection that changes less than about 200 units, less than about 150 units or less than about 100 units.

In further embodiments, the coating exhibits, e.g., an a* value from 15 degree angle to 110 degree angle from specular reflection that does not change by more than about 10 units, by more than about 5 units or more than about 2 units.

In other embodiments, the coating exhibits, e.g., a b* value from 15 degree angle to 110 degree angle from specular reflection that does not change by more than about 25 units, by more than about 15 units or more than about 10 units.

In any embodiments disclosed herein, the non-spherical photonic structures can be, e.g., direct non-spherical photonic structures or inverse non-spherical photonic structures.

In any embodiments disclosed herein, the structural colorant can exhibit, e.g., angle-dependent iridescence or angle independent color.

In any embodiments disclosed herein, the ratio of structural colorant to resinous binder is, e.g., about 1:100 to about 50:100; about 5:100 to about 25:100; about 10:100 to about 20:100 or about 15:100.

In any embodiments disclosed herein, structural colorant can comprise a metal oxide.

The metal oxide can be, e.g., selected from is selected from the group consisting of silica, titania, alumina, zirconia, ceria, iron oxides, zinc oxide, indium oxide, tin oxide, chromium oxide and combinations thereof.

In certain embodiments, the coating composition can be, e.g., selected from silica, titania and combinations thereof.

In certain embodiments, the non-spherical photonic structures can have, e.g., an average diameter of from about 1 μm to about 75 μm.

In certain embodiments, the non-spherical photonic structures can have, e.g., an average pore diameter of from about 50 nm to about 800 nm.

In certain embodiments, the non-spherical photonic structures can have, e.g., an average porosity of from about 0.45 to about 0.65.

In certain embodiments, the non-spherical photonic structures is de-agglomerated, e.g., by sonification.

In certain embodiments, at least a portion of the external surface of the structural colorant comprises silane functional groups.

In certain embodiments, the structural colorant comprises transition metal ions.

In certain embodiments, the structural colorant comprises an organic material such as carbon black.

Certain embodiments have a Zeta Potential (mV) of from about 5 to about 20; from about 8 to about 18; or about 10 to about 15.

Certain embodiments have an Intensity of from about 0 to about −100; from about −10 to about −50; about −15 to about −45; or about −40.

Certain embodiments are directed to an article of manufacture comprising a substrate and a coating as disclosed herein. The substrate can be, e.g., an automotive part such as an external panel or an interior part.

Certain embodiments are directed to a method of preparing a coating composition comprising mixing a solvent, a resinous binder and a structural colorant comprising non-spherical photonic structures to obtain the coating compositions as disclosed.

In certain embodiments, the method comprises mixing the solvent and the structural colorant and thereafter adding the resinous binder.

In certain embodiments, the method further comprises de-agglomerating the structural colorant, e.g., prior to adding the resinous binder.

In certain embodiments, the de-agglomeration is by sonification.

Certain embodiments are directed to a method of coating a substrate comprising layering a coating composition as disclosed herein onto a substrate.

In certain embodiments, the method comprises selecting the dimensions of the structural colorant to achieve a pre-determined color standard. In certain embodiments, the standard has been previously attained by the structural colorant. In other embodiments, the standard is based on a color achieved by a chemical colorant. In further embodiments, the dimensions are one or more of diameter, pore diameter and porosity.

In certain embodiments, the standard color has a wavelength of 380-450 nm, 450-485 nm, 485-500 nm, 500-565 nm, 565-590 nm, 590-625 nm or 625-704 nm. In other embodiments, the color of the layered substrate is the same or substantially the same as the standard based on spectrophotometry measurement.

### Water Base Coat

The coating compositions can be formed, e.g., by combining the structural colorants with water, and the at least one water-miscible film-forming binder to form an aqueous topcoat coating composition.

The at least one water-miscible film-forming binder may be dissolved or dispersed in an aqueous medium. Nonlimiting examples of suitable water-miscible film-forming binders may include polyurethane resins, acrylated polyurethane resins, poly(meth)acrylate polymers (acrylic polymers), polyester resins, acrylated polyester resins, polyether resins and alkyd resins. The aqueous topcoat coating composition may also include a binder system including more than one water-miscible film-forming binder.

The at least one water-miscible film-forming binder may be physically dried and/or chemically crosslinked, for example by polymerization, polycondensation, and/or polyaddition reactions. Chemically cross-linkable water-miscible film-forming binders may contain corresponding cross-linkable functional groups. Suitable functional groups may include, for example, hydroxyl groups, carbamate groups, isocyanate groups, acetoacetyl groups, unsaturated groups, for example, (meth)acryloyl groups, epoxide groups, carboxyl groups, and amino groups. The at least one water-miscible film-forming binder may be paired with or include a crosslinking agent. The crosslinking agent may include a complementarily-reactive functional group that may provide crosslinking during curing. For example, hydroxyl group-containing polymers and aminoplast (e.g., melamine) crosslinking agents may be used with chemically crosslinkable water-miscible film-forming binders.

Embodiments including aminoplast crosslinking agents may further include a strong acid catalyst to enhance curing of the aqueous topcoat coating composition. Such catalysts may include, for example, para-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts may also be blocked, e.g., with an amine.

The at least one water-miscible film-forming binder may include ionic and/or non-ionic groups such as carboxyl groups and polyethylene oxide segments. Suitable neutralizing agents for the carboxyl groups are basic compounds, such as tertiary amines, for example, triethylamine, dimethylethanolamine, and diethylethanolamine. Alternatively or additionally, the aqueous topcoat coating composition may also include one or more external emulsifiers. The external emulsifier(s) may disperse the water-miscible film-forming binder within the aqueous topcoat coating composition.

In one non-limiting example, the water-miscible film-forming binder is an aqueous polyurethane dispersion. The aqueous polyurethane dispersion may be prepared by emulsifying hydrophobic polyurethanes in water with the aid of one or more external emulsifiers. The aqueous polyurethane dispersion may also be prepared to be self-dispersible by incorporating hydrophilic groups. One technique for imparting water-miscibility or -dispersibility may include converting carboxylate groups into anionic groups using an amine to form an anionic, polyurethane dispersion. Another technique for imparting water-miscibility may include first reacting tertiary amino alcohols with prepolymers which contain free isocyanate functionality, and then neutralizing the reaction product with an acid to form a cationic polyurethane dispersion. A further technique may include modifying prepolymers having free isocyanate functions with water-soluble long-chain polyethers to form a nonionic polyurethane dispersion.

The aqueous topcoat coating composition may alternatively include a hybrid polyurethane-polyacrylate dispersion as the water-miscible film-forming binder. The hybrid polyurethane-polyacrylate dispersion may be prepared by emulsion-polymerizing a vinylpolymer, i.e., a polyacrylate, in an aqueous polyurethane dispersion. Alternatively, the hybrid polyurethane-polyacrylate dispersion may be prepared as a secondary dispersion.

The aqueous topcoat coating composition may include the non-spherical photonic structures in an amount of from about 0.01 part by weight to about 60 parts by weight, e.g., from about 1.0 part by weight to about 20 parts by weight, based on 100 parts by weight of the water-miscible film-forming binder. That is, blending may include adding to water from about 30 parts by weight non-spherical photonic structures to about 50 parts by weight non-spherical photonic structures based on 100 parts by weight of the at least one water-miscible film-forming binder.

The aqueous topcoat coating composition may further include a rheology control agent and/or film-forming agent such as a colloidal layered silicate. For example, the colloidal layered silicate may provide the aqueous topcoat coating composition with stability and adjust a thixotropic shear-sensitive viscosity of the aqueous topcoat coating composition. The colloidal layered silicate may be synthetically manufactured from an inorganic mineral and may have a colloidal, gel, or sol form. A suitable colloidal layered silicate is commercially available under the trade name Laponite® from the Byk-Chemie GmbH of Wesel, Germany. Therefore, the method may further include blending the colloidal layered silicate, the passivated pigment slurry, water, and the at least one water-miscible film-forming binder to form the aqueous topcoat coating composition.

The aqueous topcoat coating composition may also include other pigments and fillers. Nonlimiting examples of other pigments and fillers may include inorganic pigments such as titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium, ferrocyanide (Prussian blue), and ultramarine, and organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, nanoparticles based on silicon dioxide, and aluminum oxide or zirconium oxide. The additional pigments can also include one or more flake-like pigments such as aluminum flakes or mica-based flakes.

The pigments may be dispersed in a resin or polymer or may be present in a pigment system which includes a pigment dispersant, such as the water-miscible film-forming binder resins of the kind already described. The pigment and dispersing resin, polymer, or dispersant may be brought into contact under a shear sufficient to break any agglomerated pigment down to primary pigment particles and to wet a surface of the pigment particles with the dispersing resin, polymer, or dispersant. The breaking of the agglomerates and wetting of the primary pigment particles may provide pigment stability and robust color.

The pigments and fillers may be present in the aqueous topcoat coating composition in an amount of less than or equal to about 60 parts by weight based on 100 parts by weight of the aqueous topcoat coating composition. For example, the pigments and fillers may be present in the aqueous topcoat coating composition in an amount of from about 0.5 parts by weight to 50 parts by weight, or from about 1 part by weight to about 30 parts by weight, or from about 2 parts by weight to about 20 parts by weight, or from about 2.5 parts by weight to about 10 parts by weight, based on 100 parts by weight of the aqueous topcoat coating composition. The amount of pigments and fillers present in the aqueous topcoat coating composition may be selected according to a make-up or nature of the pigment, on a depth of desired color of the cured film formed from the aqueous topcoat coating composition, on an intensity of a metallic and/or pearlescent effect of the cured film, and/or on a dispersibility of the pigment.

The aqueous topcoat coating composition may also include additive components such as, but not limited to, surfactants, stabilizers, dispersing agents, adhesion promoters, ultraviolet light absorbers, hindered amine light stabilizers, benzotriazoles or oxalanilides, free-radical scavengers, slip additives, defoamers, reactive diluents, wetting agents such as siloxanes, fluorine compounds, carboxylic monoesters, phosphoric esters, polyacrylic acids and their copolymers, for example polybutyl acrylate and polyurethanes, adhesion promoters such as tricyclodecanedimethanol, flow control agents, film-forming assistants such as cellulose derivatives, and rheology control additives such as inorganic phyllosilicates such as aluminum-magnesium silicates, sodium-magnesium, and sodium-magnesium-fluorine-lithium phyllosilicates of the montmorillonite type. The aqueous topcoat coating composition 14 may include one or a combination of such additives.

The aqueous topcoat coating composition may be suitable for coating automotive components and substrates and may be suitable for original finish and refinish automotive applications. Further, the aqueous topcoat coating composition may be characterized as a monocoat coating composition, and may be structured to be applied to the substrate as a single, uniformly-pigmented layer. Alternatively, the aqueous topcoat coating composition may be characterized as a basecoat/clearcoat coating composition, and may be structured to be applied to the substrate as two distinct layers, i.e., a lower, highly pigmented layer or basecoat, and an upper layer or clearcoat having little or no pigmentation. Basecoat/clearcoat coating compositions may impart a comparatively high level of gloss and depth of color.

### Forming the Aqueous Topcoat Coating System

The method of forming the aqueous topcoat coating system includes combining, reacting, and blending. The method further includes applying a film formed from the aqueous topcoat coating composition to the substrate. Applying may include, for example, spray coating, dip coating, roll coating, curtain coating, knife coating, spreading, pouring, dipping, impregnating, trickling, rolling, and combinations thereof. For automotive applications in which the substrate is, for example, a body panel, applying may include spray coating the aqueous topcoat coating composition onto the substrate. Nonlimiting example of suitable spray coating may include compressed-air spraying, airless spraying, high-speed rotation, electrostatic spray application, hot-air spraying, and combinations thereof. During applying, the substrate may be at rest, and application equipment configured for applying the aqueous topcoat coating composition to the substrate may be moved. Alternatively the substrate, e.g., a coil, may be moved, and the application equipment may be at rest relative to the substrate.

Nonlimiting examples of suitable substrates include metal substrates such as bare steel, phosphated steel, galvanized steel, or aluminum; and non-metallic substrates, such as plastics and composites. The substrate 44 may also include a layer formed from another coating composition, such as a layer formed from an electrodeposited primer coating composition, primer surfacer composition, and/or basecoat coating composition, whether cured or uncured.

For example, the substrate may be pretreated to include a layer formed from an electrodeposition (electrocoat) primer coating composition. The electrodeposition primer coating composition may be any electrodeposition primer coating composition useful for automotive vehicle coating operations. The electrodeposition primer coating composition may have a dry film thickness of from about 10 μm to about 35 μm and may be curable by baking at a temperature of from about 135° C. to about 190° C. for a duration of from about 15 minutes to about 60 minutes. Nonlimiting examples of electrodeposition primer coating compositions are commercially available under the trade name CathoGuard® from BASF Corporation of Florham Park, N.J.

Such electrodeposition primer coating compositions may include an aqueous dispersion or emulsion including a principal film-forming epoxy resin having ionic stabilization, e.g., salted amine groups, in water or a mixture of water and an organic cosolvent. The principal film-forming resin may be emulsified with a crosslinking agent that is reactive with functional groups of the principal film-forming resin under certain conditions, such as when heated, so as to cure a layer formed from the electrodeposition primer coating composition. Suitable examples of crosslinking agents, include, without limitation, blocked polyisocyanates. The electrodeposition primer coating compositions may further include one or more pigments, catalysts, plasticizers, coalescing aids, antifoaming aids, flow control agents, wetting agents, surfactants, ultraviolet light absorbers, hindered amine light stabilizer compounds, antioxidants, and other additives.

The method also includes curing the film to form the aqueous topcoat coating composition. Curing may include, for example, drying the aqueous topcoat coating composition so that at least some of any solvent and/or water is stripped from the film during an evaporation phase. Drying may include heating the film at a temperature of from about room temperature to about 80° C. Subsequently, the film may be baked, for example, under conditions employed for automotive original equipment manufacturer finishing, such as at temperatures from about 30° C. to about 200° C., or from about 70° C. to about 180° C., or from about 90° C. to about 160° C., for a duration of from about 20 minutes to about 10 hours, e.g., about 20 minutes to about 30 minutes for comparatively lower baking temperatures and from about 1 hour to about 10 hours for comparatively higher baking temperatures. In one example, the film may be cured at a temperature of from about 90° C. to about 160° C. for a duration of about 1 hour.

In addition, curing may not occur immediately after applying. Rather, curing may include allowing the film to rest or “flash”. That is, the film may be cured after a certain rest time or “flash” period. The rest time allows the aqueous topcoat coating composition to, for example, level and devolatilize such that any volatile constituents such as solvents may evaporate. Such a rest time may be assisted or shortened by the exposing the film to elevated temperatures or reduced humidity. Curing of the aqueous topcoat coating composition may include heating the film in a forced-air oven or irradiating the film with infrared lamps.

The resulting cured film may have a thickness of from about 5 μm to about 75 μm, e.g., about 30 μm to about 65 μm, depending, for example, upon a desired color or continuity of the cured film. Further, the cured film formed from the aqueous topcoat coating composition 14 may exhibit a metallic and/or pearlescent appearance.

Therefore, the aqueous topcoat coating system may include the substrate and the cured film formed from the aqueous topcoat coating composition and disposed on the substrate. Therefore, the method may also include, after curing, exposing the cured film to light without photo-degrading the cured film. That is, the first layer and the second layer of the passivated pigment slurry may provide the cured film formed from the aqueous topcoat coating composition with excellent photo-degradation protection upon exposure to wavelengths from ultraviolet light, visible light, and/or infrared radiation.

As such, the non-spherical photonic structure slurry or dispersion may be used in coating compositions for original finish and refinish automotive coating compositions, such as multicoat coating systems comprising at least one basecoat and at least one clearcoat disposed on the at least, in which the basecoat has been produced using the non-spherical photonic structure slurry.

Nonlimiting examples of suitable clearcoat coating compositions may include poly(meth)acrylate polymers, polyvinyl polymers, and polyurethanes. For example, the clearcoat composition may include a carbamate- and/or hydroxyl-functional poly(meth)acrylate polymer. For embodiments including a polymer having hydroxyl and/or carbamate functional groups, the crosslinking agent may be an aminoplast resin.

### Solvent Base Coat

In certain embodiments, the coating compositions may include one or more organic solvents. Nonlimiting examples of suitable solvents include aromatic hydrocarbons, ketones, esters, glycol ethers, and esters of glycol ethers. Specific examples include, without limitation, methyl ethyl ketone, methyl isobutyl ketone, m-amyl acetate, ethylene glycol butyl ether and ethylene glycol monobutyl ether acetate, propylene glycol monomethyl ether and propylene glycol monomethyl ether acetate, xylene, ethanol, propanol, isopropanol, n-butanol, isobutanol, tert-butanol, N-methyl pyrrolidone, N-ethyl pyrrolidone, Aromatic 100, Aromatic 150, naphtha, mineral spirits, butyl glycol, and so on.

The coating composition may optionally include further rheology control agents, including high molecular weight mixed cellulose esters, such as CAB-381-0.1, CAB-381-20. CAB-531-1, CAB-551-0.01, and CAB-171-15S (available from Eastman Chemical Company, Kingsport, Tenn.), which may be included in amounts of up to about 5 wt. %, or from about 0.1 to about 5 wt. %, or from about 1.5 to about 4.5 wt. %, based on total binder weight. Further examples include microgel rheology control agents such as crosslinked acrylic polymeric microparticles, which may be included in amounts of up to about 5 wt. % of total binder weight; wax rheology control agents such as polyethylene waxes including acrylic acid-modified polyethylene wax (e.g., Honeywell A-C® Performance Additives), poly(ethylene-vinyl acetate) copolymers, and oxidized polyethylenes, which may be included in amounts of up to about 2 wt. % on total binder weight; and fumed silicas, which may be included in amounts of up to about 10 wt. % on total binder weight or from about 3 to about 12 wt. % on total binder weight.

Additional agents, for example hindered amine light stabilizers, ultraviolet light absorbers, anti-oxidants, surfactants, stabilizers, wetting agents, adhesion promoters, etc. may be incorporated into the coating composition. Such additives are well-known and may be included in amounts typically used for coating compositions.

Nonlimiting examples of special effect pigments that may be utilized in basecoat and monocoat topcoat coating compositions include metallic, pearlescent, and color-variable effect flake pigments. Metallic (including pealescent, and color-variable) topcoat colors are produced using one or more special flake pigments. Metallic colors are generally defined as colors having gonioapparent effects. For example, the American Society of Testing Methods (ASTM) document F284 defines metallic as “pertaining to the appearance of a gonioapparent material containing metal flake.” Metallic basecoat colors may be produced using metallic flake pigments like aluminum flake pigments, coated aluminum flake pigments, copper flake pigments, zinc flake pigments, stainless steel flake pigments, and bronze flake pigments and/or using pearlescent flake pigments including treated micas like titanium dioxide-coated mica pigments and iron oxide-coated mica pigments to give the coatings a different appearance (degree of reflectance or color) when viewed at different angles. Metal flakes may be cornflake type, lenticular, or circulation-resistant; micas may be natural, synthetic, or aluminum-oxide type. Flake pigments do not agglomerate and are not ground under high shear because high shear would break or bend the flakes or their crystalline morphology, diminishing or destroying the gonioapparent effects. The flake pigments are satisfactorily dispersed in a binder component by stirring under low shear. The flake pigment or pigments may be included in the high solids coating composition in an amount of about 0.01 wt. % to about 0.3 wt. % or about 0.1 wt. % to about 0.2 wt. %, in each case based on total binder weight.

Nonlimiting examples of commercial flake pigments include PALIOCROME® pigments, available from BASF Corporation.

Nonlimiting examples of other suitable pigments and fillers that may be utilized in basecoat and monocoat topcoat coating compositions include inorganic pigments such as titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), and ultramarine, and organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and so on. The pigment or pigments are preferably dispersed in a resin or polymer or with a pigment dispersant, such as binder resins. In general, the pigment and dispersing resin, polymer, or dispersant are brought into contact under a shear high enough to break the pigment agglomerates down to the primary pigment particles and to wet the surface of the pigment particles with the dispersing resin, polymer, or dispersant. The breaking of the agglomerates and wetting of the primary pigment particles are important for pigment stability and color development. Pigments and fillers may be utilized in amounts typically of up to about 40% by weight, based on total weight of the coating composition.

In certain embodiments, the disclosed basecoats may have about 40 wt. % to about 55 wt. %, nonvolatile content, and typically may have about 45 wt. % to about 50 wt. % nonvolatile content, as determined by ASTM Test Method D2369, in which the test sample is heated at 110° C. (230° F.) for 60 minutes.

In certain embodiments, a substrate may be coated by applying a primer layer, optionally curing the primer layer; then applying a basecoat layer and a clearcoat layer, typically wet-on-wet, and curing the applied layers and optionally curing the primer layer along with the basecoat and clearcoat layers if the primer layer is not already cured, or then applying a monocoat topcoat layer and curing the monocoat topcoat layer, again optionally curing the primer layer along with the basecoat and clearcoat layers if the primer layer is not already cured. The cure temperature and time may vary depending upon the particular binder components selected, but typical industrial and automotive thermoset compositions prepared as we have described may be cured at a temperature of from about 105° C. to about 175° C., and the length of cure is usually about 15 minutes to about 60 minutes.

The coating composition can be coated on a substrate by spray coating. Electrostatic spraying is a preferred method. The coating composition can be applied in one or more passes to provide a film thickness after cure of a desired thickness, typically from about 10 to about 40 microns for primer and basecoat layers and from about 20 to about 100 microns for clearcoat and monocoat topcoat layers.

The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

The substrate may be first primed with an electrodeposition (electrocoat) primer. The electrodeposition composition can be any electrodeposition composition used in automotive vehicle coating operations. Non-limiting examples of electrocoat compositions include the CATHOGUARD® electrocoating compositions sold by BASF Corporation, such as CATHOGUARD® 500. Electrodeposition coating baths usually comprise an aqueous dispersion or emulsion including a principal film-forming epoxy resin having ionic stabilization (e.g., salted amine groups) in water or a mixture of water and organic cosolvent. Emulsified with the principal film-forming resin is a crosslinking agent that can react with functional groups on the principal resin under appropriate conditions, such as with the application of heat, and so cure the coating. Suitable examples of crosslinking agents, include, without limitation, blocked polyisocyanates. The electrodeposition coating compositions usually include one or more pigments, catalysts, plasticizers, coalescing aids, antifoaming aids, flow control agents, wetting agents, surfactants, UV absorbers, HALS compounds, antioxidants, and other additives.

The electrodeposition coating composition is preferably applied to a dry film thickness of 10 to 35 micron. After application, the coated vehicle body is removed from the bath and rinsed with deionized water. The coating may be cured under appropriate conditions, for example by baking at from about 275° F. to about 375° F. (about 135° C. to about 190° C.) for between about 15 and about 60 minutes.

### Alternative Embodiments

In certain embodiments, the non-spherical photonic structures utilized in the present invention comprise a metal oxide and an organic material. In certain embodiments, the organic material is present in an amount of from about 0.1% to about 50% w/w of the non-spherical photonic structures. In certain embodiments, the non-spherical photonic structures comprise from about 0.5% to about 25% of an organic material; from about 1% to about 10% of an organic material or from about 2% to about 8% of an organic material.

In certain embodiments, the organic material is within the pores of the non-spherical photonic structures, on the surface of the non-spherical photonic structures or a combination thereof.

In certain embodiments, the organic material is derived from decomposition (e.g., by combustion) of a precursor such as a saccharide.

In certain embodiments, the organic material is carbon black.

In certain embodiments, the non-spherical photonic structures utilized in the present invention comprises a metal oxide and a transition metal. In certain embodiments, the molar ratio of transition metal to metal oxide being less than about 2:1.

In certain embodiments, the non-spherical photonic structures have a molar ratio of transition metal to metal oxide from about 1:100 to about 1:1; about 1:50 to about 1:2 or about 1:5 to about 1:10.

In certain embodiments, the transition metal is selected from one or more of a Group 3 to 12 transition metal of the periodic table; a Group 4 to 11 transition metal on the periodic table; or a Group 8 to 10 transition metal on the periodic table. In one embodiment, the transition metal is cobalt.

In certain embodiments, the non-spherical photonic structures utilized in the present invention comprise metal oxide particles and silane functional groups on at least a portion of the external surface of the metal oxide particles.

In certain embodiments the silane functional groups are epoxy silanes, amino silanes, alkyl silanes, alkylhalosilanes or a combination thereof.

In certain embodiments the silyl functional groups are derived from reacting the porous metal oxide non-spherical photonic structures with a silane coupling agent.

In certain embodiments, the silane coupling agent comprises an organo functional group and a hydrolysable functional group bonded directly or indirectly to silicone.

In certain embodiments, the hydrolysable functional group is an alkoxy group.

In certain embodiments, the silyl functional groups are aminoethyl trimethoxy silanes, aminopropyl trimethoxysilanes, glycidoxypropyl trimethoxy silanes or a combination thereof. Certain embodiments can further comprise an acrylic functional resin.

In certain embodiments, the alkylhalosilane is an alkylchlorosilane. In other embodiments, the silane functional groups are decyltrichlorosilanes, perfluorooctyl-trichlorosilanes or a combination thereof.

In other embodiments, the silyl functional groups prevent or substantially prevent the infiltration of the liquid medium into pores of the structural colorants.

In certain embodiments, the reflective spectra of the silane functionalized non-spherical photonic structures after storage for 24 hours at room temperature, standard atmosphere and relative humidity has a wavelength within 10% of the liquid coating composition prior to storage.

In certain embodiments, the reflective spectra of the silane functionalized non-spherical photonic structures after storage for 2 days, 5 days, 7 days, 14 days or 28 days at room temperature, standard atmosphere and relative humidity has a wavelength within 8%, 5%, 4% or 2% of the liquid coating composition prior to storage.

Certain embodiments exhibit a wavelength range selected from the group consisting of 380 to 450 nm, 451 to 495 nm, 496 to 570 nm, 571 to 590 nm, 591, 620 nm and 621 to 750 nm.

In certain embodiments, the structural colorant non-spherical photonic structures can have, e.g., one or more of an average diameter of from about 0.5 μm to about 100 μm, an average porosity of from about 0.10 to about 0.80 and an average pore diameter of from about 50 nm to about 999 nm. In alternative embodiments, the particles can have, e.g., one or more of an average diameter of from about 1 μm to about 75 μm, an average porosity of from about 0.45 to about 0.65 and an average pore diameter of from about 50 nm to about 800 nm.

In certain embodiments, the structural colorant non-spherical photonic structures have an average diameter, e.g., of from about 1 μm to about 75 μm, from about 2 μm to about 70 μm, from about 3 μm to about 65 μm, from about 4 μm to about 60 μm, from about 5 μm to about 55 μm or from about 5 μm to about 50 μm; for example from any of about 5 μm, about 6 μm, about 7 μm, about 8 μm, or about 9 μm, or about 10 μm, or about 11 μm, or about 12 μm, or about 13 μm, about 14 μm or about 15 μm to any of about 16 μm, or about 17 μm, or about 18 μm, or about 19 μm, about 20 μm, or about 21 μm, or about 22 μm, or about 23 μm, or about 24 μm or about 25 μm. Alternative embodiments can have an average diameter of from any of about 4.5 μm, or about 4.8 μm, about 5.1 μm, or about 5.4 μm, or about 5.7 μm, or about 6.0 μm, or about 6.3 μm, or about 6.6 μm, about 6.9 μm, or about 7.2 μm or about 7.5 μm to any of about 7.8 μm about 8.1 μm, or about 8.4 μm, about 8.7 μm, or about 9.0 μm, or about 9.3 μm, or about 9.6 μm or about 9.9 μm.

In other embodiments, the structural colorant non-spherical photonic structures have an average porosity, e.g., of from any of about 0.10, about 0.12, about 0.14, about 0.16, about 0.18, about 0.20, about 0.22, about 0.24, about 0.26, about 0.28, about 0.30, about 0.32, about 0.34, about 0.36, about 0.38, about 0.40, about 0.42, about 0.44, about 0.46, about 0.48 about 0.50, about 0.52, about 0.54, about 0.56, about 0.58 or about 0.60 to any of about 0.62, about 0.64, about 0.66, about 0.68, about 0.70, about 0.72, about 0.74, about 0.76, about 0.78, about 0.80 or about 0.90. Alternative embodiments can have an average porosity of from any of about 0.45, about 0.47, about 0.49, about 0.51, about 0.53, about 0.55 or about 0.57 to any of about 0.59, about 0.61, about 0.63 or about 0.65.

In further embodiments, the structural colorant non-spherical photonic structures have an average pore diameter, e.g., of from any of about 50 nm, about 60 nm, about 70 nm, 80 nm, about 100 nm, about 120 nm, about 140 nm, about 160 nm, about 180 nm, about 200 nm, about 220 nm, about 240 nm, about 260 nm, about 280 nm, about 300 nm, about 320 nm, about 340 nm, about 360 nm, about 380 nm, about 400 nm, about 420 nm or about 440 nm to any of about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm or about 800 nm. Alternative embodiments can have an average pore diameter of from any of about 220 nm, about 225 nm, about 230 nm, about 235 nm, about 240 nm, about 245 nm or about 250 nm to any of about 255 nm, about 260 nm, about 265 nm, about 270 nm, about 275 nm, about 280 nm, about 285 nm, about 290 nm, about 295 nm or about 300 nm.

In further embodiments, the structural colorant non-spherical photonic structures can have, e.g., an average diameter of from any of about 4.5 μm, or about 4.8 μm, or about 5.1 μm, about 5.4 μm, or about 5.7 μm, or about 6.0 μm, or about 6.3 μm, or about 6.6 μm, or about 6.9 μm, or about 7.2 μm or about 7.5 μm to any of about 7.8 μm about 8.1 μm, about 8.4 μm, or about 8.7 μm, or about 9.0 μm, about 9.3 μm, or about 9.6 μm or about 9.9 μm; an average porosity of from any of about 0.45, about 0.47, about 0.49, about 0.51, about 0.53, about 0.55 or about 0.57 to any of about 0.59, about 0.61, about 0.63 or about 0.65; and an average pore diameter of from any of about 220 nm, about 225 nm, about 230 nm, about 235 nm, about 240 nm, about 245 nm or about 250 nm to any of about 255 nm, about 260 nm, about 265 nm, about 270 nm, about 275 nm, about 280 nm, about 285 nm, about 290 nm, about 295 nm or about 300 nm.

In further embodiments, the structural colorant non-spherical photonic structures can have, e.g., from about 60.0 wt % to about 99.9 wt % metal oxide, based on the total weight of the colorants. In other embodiments, the structural colorants comprise from about 0.1 wt % to about 40.0 wt % of one or more light absorbers, based on the total weight of the colorants. In other embodiments, the metal oxide is from any of about 60.0 wt %, about 64.0 wt %, about 67.0 wt %, about 70.0 wt %, about 73.0 wt %, about 76.0 wt %, about 79.0 wt %, about 82.0 wt % or about 85.0 wt % to any of about 88.0 wt %, about 91.0 wt %, about 94.0 wt %, about 97.0 wt %, about 98.0 wt %, about 99.0 wt % or about 99.9 wt % metal oxide, based on the total weight of the structural colorant.

In certain embodiments, the structural colorant non-spherical photonic structures are prepared by a process comprising forming a liquid dispersion of polymer non-spherical particles and a metal oxide; drying the dispersion to provide polymer template particles comprising polymer and metal oxide; and removing the polymer from the template non-spheres to provide metal oxide particles. In such embodiments, the particles may be porous and/or monodisperse.

In other embodiments, the structural colorant non-spherical photonic structures are prepared by a process comprising forming a liquid dispersion of monodisperse non-spherical polymer particles; forming at least one further liquid solution or dispersion of monodisperse non-spherical polymer particles; mixing each of the solutions or dispersions together; drying the dispersion to provide polymer particles that are polydisperse when the average diameters of the monodisperse polymer particles of each of the dispersions are different. In certain such embodiments, the particles are porous.

In certain embodiments, the structural colorant non-spherical photonic structures are prepared by a process comprising forming a dispersion of polymer particles and a metal oxide in a liquid medium; evaporating the liquid medium to obtain polymer-metal oxide particles; and calcining the particles to obtain the structural colorants. In these embodiments, the evaporation of the liquid medium may be performed in the presence of self-assembly substrates such as conical tubes or photolithography slides. In certain such embodiments, the particles are porous.

In certain embodiments, the structural colorants may be recovered, e.g., by filtration or centrifugation.

In certain embodiments, the drying comprises microwave irradiation, oven drying, drying under vacuum, drying in the presence of a desiccant, or a combination thereof

In certain embodiments, the wt/wt ratio of polymer particles to the metal oxide is from about 0.5/1 to about 10.0/1. In other embodiments, the wt/wt ratio is from any of about 0.1/1, about 0.5/1, about 1.0/1, about 1.5/1, about 2.0/1, about 2.5/1 or about 3.0/1 to any of about 3.5/1, about 4.0/1, about 5.0/1, about 5.5/1, about 6.0/1, about 6.5/1, about 7.0/1, about 8.0/1, about 9.0/1 or about 10.0/1.

In certain embodiments, the polymer particles have an average diameter of from about 50 nm to about 990 nm. In other embodiments, the particles have an average diameter of from any of about 50 nm, about 75 nm, about 100 nm, about 130 nm, about 160 nm, about 190 nm, about 210 nm, about 240 nm, about 270 nm, about 300 nm, about 330 nm, about 360 nm, about 390 nm, about 410 nm, about 440 nm, about 470 nm, about 500 nm, about 530 nm, about 560 nm, about 590 nm or about 620 nm to any of about 650 nm, about 680 nm, about 710 nm, about 740 nm, about 770 nm, about 800 nm, about 830 nm, about 860 nm, about 890 nm, about 910 nm, about 940 nm, about 970 nm or about 990 nm.

In certain embodiments, the polymer is selected from the group consisting of poly(meth)acrylic acid, poly(meth)acrylates, polystyrenes, polyacrylamides, polyethylene, polypropylene, polylactic acid, polyacrylonitrile, derivatives thereof, salts thereof, copolymers thereof and combinations thereof. The polystyrenes can be, e.g., polystyrene copolymers such as polystyrene/acrylic acid, polystyrene/poly(ethylene glycol) methacrylate or polystyrene/styrene sulfonate.

In certain embodiments, the metal oxide is selected from the group consisting of silica, titania, alumina, zirconia, ceria, iron oxides, zinc oxide, indium oxide, tin oxide, chromium oxide and combinations thereof.

In certain embodiments, removing the non-spherical photonic structures from the template non-spheres comprises calcination, pyrolysis or solvent removal. The calcining of the template non-spheres can be, e.g., at temperatures of from about 300° C. to about 800° C. for a period of from about 1 hour to about 8 hours.

In certain embodiments disclosed herein, the structural colorant non-spherical photonic structures can be metal oxide particles which may be prepared with the use of a polymeric sacrificial template. In one embodiment, an aqueous colloid dispersion containing polymer particles and a metal oxide is prepared, the polymer particles being, e.g., nano-scaled. The aqueous colloidal dispersion is mixed with a continuous oil phase, for instance within a microfluidic device, to produce a water-in-oil emulsion. Emulsion aqueous droplets are prepared, collected and dried to form particles (e.g., platelet-like) containing polymer particles (e.g., nanoparticles) and metal oxide. Alternatively, the particles can be prepared by evaporation. The polymer particles are then removed, for instance via calcination, to provide metal oxide particles that are, e.g., micron-scaled, and that contain a high degree of porosity with, e.g., nano-scaled pores. The particles may contain uniform pore diameters as a result of the polymer particles being spherical and monodisperse. The removal of the polymer particles form an “inverse structure” or inverse opal. The particles prior to calcination are considered to be a “direct structure” or direct opal.

The structural colorant non-spherical photonic structures in certain embodiments are porous and can be advantageously sintered, resulting in a continuous solid structure which is thermally and mechanically stable.

Suitable template polymers include thermoplastic polymers. For example, template polymers are selected from the group consisting of poly(meth)acrylic acid, poly(meth)acrylates, polystyrenes, polyacrylamides, polyvinyl alcohol, polyvinyl acetate, polyesters, polyurethanes, polyethylene, polypropylene, polylactic acid, polyacrylonitrile, polyvinyl ethers, derivatives thereof, salts thereof, copolymers thereof and combinations thereof. For example, the polymer is selected from the group consisting of polymethyl methacrylate, polyethyl methacrylate, poly(n-butyl methacrylate), polystyrene, poly(chloro-styrene), poly(alpha-methyl styrene), poly(N-methylolacrylamide), styrene/methyl methacrylate copolymer, polyalkylated acrylate, polyhydroxyl acrylate, polyamino acrylate, polycyanoacrylate, polyfluorinated acrylate, poly(N-methylolacrylamide), polyacrylic acid, polymethacrylic acid, methyl methacrylate/ethyl acrylate/acrylic acid copolymer, styrene/methyl methacrylate/acrylic acid copolymer, polyvinyl acetate, polyvinylpyrrolidone, polyvinylcaprolactone, polyvinylcaprolactam, derivatives thereof, salts thereof, and combinations thereof.

In certain embodiments, polymer templates include polystyrenes, including polystyrene and polystyrene copolymers. Polystyrene copolymers include copolymers with water-soluble monomers, for example polystyrene/acrylic acid, polystyrene/poly(ethylene glycol) methacrylate, and polystyrene/styrene sulfonate.

Present metal oxides include oxides of transition metals, metalloids and rare earths, for example silica, titania, alumina, zirconia, ceria, iron oxides, zinc oxide, indium oxide, tin oxide, chromium oxide, mixed metal oxides, combinations thereof, and the like.

The wt/wt (weight/weight) ratio of polymer nanoparticles to metal oxide is for instance from about 0.1/1 to about 10.0/1 or from about 0.5/1 to about 10.0/1.

Polymer removal may be performed for example via calcination, pyrolysis or with a solvent (solvent removal). Calcination is performed in some embodiments at temperatures of at least about 200° C., at least about 500° C., at least about 1000° C., from about 200° C. to about 1200° C. or from about 200° C. to about 700° C. The calcining can be for a suitable period, e.g., from about 0.1 hour to about 12 hours or from about 1 hour to about 8.0 hours. In other embodiments, the calcining can be for at least about 0.1 hour, at least about 1 hour, at least about 5 hours or at least about 10 hours. In other embodiments, the calcining can be from any of about 200° C., about 350° C., about 400° C., 450° C., about 500° C. or about 550° C. to any of about 600° C., about 650° C., about 700° C. or about 1200° C. for a period of from any of about 0.1 h (hour), 1 h, about 1.5 h, about 2.0 h, about 2.5 h, about 3.0 h, about 3.5 h or about 4.0 h to any of about 4.5 h, about 5.0 h, about 5.5 h, about 6.0 h, about 6.5 h, about 7.0 h, about 7.5 h about 8.0 h or about 12 h.

The structural colorant non-spherical photonic structures may be micron-scaled, for example having average diameters from about 0.5 microns (μm) to about 100 μm. The polymer particles employed as a template may also be non-spherical and nano-scaled and are monodisperse, having average diameters for instance from about 50 nm to about 999 nm. The polymer particles may also be polydisperse by being a mixture of monodisperse particles. The metal oxide employed may also be in particle form, which particles may be nano-scaled.

The metal oxide of the dispersion may be provided as metal oxide or may be provided from a metal oxide precursor, for instance via a sol-gel technique.

Drying of the polymer/metal oxide particles followed by removal of the polymer provides particles having voids (pores). The pore diameters are dependent on the size of the polymer particles. Some compaction may occur upon polymer removal, providing pore sizes somewhat smaller than the original polymer particle size, for example from about 10% to about 40% smaller than the polymer particle size. The pore diameters are uniform as are the polymer particle shape and size.

Pore diameters may range in some embodiments from about 50 nm to about 999 nm.

The average porosity of the present metal oxide particles may be relatively high, for example from about 0.10 or about 0.30 to about 0.80 or about 0.90. Average porosity of a particle means the total pore volume, as a fraction of the volume of the entire particle. Average porosity may be called “volume fraction.”

In some embodiments, porous structural colorant non-spherical photonic structures may have a solid core (center) where the porosity is in general towards the exterior surface of the particle. In other embodiments, a porous particle may have a hollow core where a major portion of the porosity is towards the interior of the particle. In other embodiments, the porosity may be distributed throughout the volume of the particle. In other embodiments, the porosity may exist as a gradient, with higher porosity towards the exterior surface of the particle and lower or no porosity (solid) towards the center; or with lower porosity towards the exterior surface and with higher or complete porosity (hollow) towards the center.

For any porous non-spherical particle, the average sphere diameter is larger than the average pore diameter, for example, the average sphere diameter is at least about 25 times, at least about 30 times, at least about 35 times, or at least about 40 times larger than the average pore diameter.

In some embodiments, the ratio of average non-sphere diameter to average pore diameter is for instance from any of about 40/1, about 50/1, about 60/1, about 70/1, about 80/1, about 90/1, about 100/1, about 110/1, about 120/1, about 130/1, about 140/1, about 150/1, about 160/1, about 170/1, about 180/1 or about 190/1 to any of about 200/1, about 210/1, about 220/1, about 230/1, about 240/1, about 250/1, about 260/1, about 270/1, about 280/1, about 290/1, about 300/1, about 310/1, about 320/1, about 330/1, about 340/1 or about 350/1.

Polymer template particles comprising monodisperse polymer particles may provide, when the polymer is removed, metal oxide non-spheres having pores that in general have similar pore diameters. In other embodiments, polydisperse polymer particles can be used wherein the average diameters of the particles are different.

Also disclosed are polymer particles comprising more than one population of monodisperse polymer particles, wherein each population of monodisperse polymer particles has different average diameters.

In certain embodiments, the structural colorant non-spherical photonic structures comprise mainly metal oxide, that is, they may consist essentially of or consist of metal oxide. Advantageously, a bulk sample of the particles exhibits color observable by the human eye. A light absorber may also be present in the particles, which may provide a more saturated observable color. Absorbers include inorganic and organic pigments, for example a broadband absorber such as carbon black. Absorbers may for instance be added by physically mixing the particles and the absorbers together or by including the absorbers in the droplets to be dried. For carbon black, controlled calcination may be employed to produce carbon black in situ from polymer decomposition. A present particle may exhibit no observable color without added light absorber and exhibit observable color with added light absorber.

The structural colorant non-spherical photonic structures utilized in the present invention may exhibit angle-dependent color or angle-independent color. “Angle-dependent” color means that observed color has dependence on the angle of incident light on a sample or on the angle between the observer and the sample. “Angle-independent” color means that observed color has substantially no dependence on the angle of incident light on a sample or on the angle between the observer and the sample.

Angle-dependent color may be achieved for example with the use of monodisperse polymer non-spherical photonic structures. Angle-dependent color may also be achieved when a step of drying to provide polymer template non-spherical photonic structures is performed slowly, allowing the polymer non-spheres to become ordered. Angle-independent color may be achieved when a step of drying is performed quickly, not allowing the polymer non-spheres to become ordered.

In certain embodiments, the structural colorant non-spherical photonic structures may comprise from about 60.0 wt % (weight percent) to about 99.9 wt % metal oxide and from about 0.1 wt % to about 40.0 wt % of one or more light absorbers, based on the total weight of the particles. In other embodiments, the light absorber can be, e.g., from about 0.1 wt % to about 40.0 wt % of one or more light absorbers, for example comprising from any of about 0.1 wt %, about 0.3 wt %, about 0.5 wt %, about 0.7 wt %, about 0.9 wt %, about 1.0 wt %, about 1.5 wt %, about 2.0 wt %, about 2.5 wt %, about 5.0 wt %, about 7.5 wt %, about 10.0 wt %, about 13.0 wt %, about 17.0 wt %, about 20.0 wt % or about 22.0 wt % to any of about 24.0 wt %, about 27.0 wt %, about 29.0 wt %, about 31.0 wt %, about 33.0 wt %, about 35.0 wt %, about 37.0 wt %, about 39.0 wt % or about 40.0 wt % of one or more light absorbers, based on the total weight of the particles.

According to the invention, particle size is synonymous with particle diameter and is determined for instance by scanning electron microscopy (SEM) or transmission electron microscopy (TEM). Average particle size is synonymous with D50, meaning half of the population resides above this point, and half below. Particle size refers to primary particles. Particle size may be measured by laser light scattering techniques, with dispersions or dry powders.

Mercury porosimetry analysis can be used to characterize the porosity of the particles. Mercury porosimetry applies controlled pressure to a sample immersed in mercury. External pressure is applied for the mercury to penetrate into the voids/pores of the material. The amount of pressure required to intrude into the voids/pores is inversely proportional to the size of the voids/pores. The mercury porosimeter generates volume and pore size distributions from the pressure versus intrusion data generated by the instrument using the Washburn equation. For example, porous silica particles containing voids/pores with an average size of 165 nm have an average porosity of 0.8.

The term “bulk sample” means a population of particles. For example, a bulk sample of particles is simply a bulk population of particles, for instance ≥0.1 mg, ≥0.2 mg, ≥0.3 mg, ≥0.4 mg, ≥0.5 mg, ≥0.7 mg, ≥1.0 mg, ≥2.5 mg, ≥5.0 mg, ≥10.0 mg or ≥25.0 mg. A bulk sample of particles may be substantially free of other components.

The phrase “exhibits color observable by the human eye” means color will be observed by an average person. This may be for any bulk sample distributed over any surface area, for instance a bulk sample distributed over a surface area of from any of about 1 cm², about 2 cm², about 3 cm², about 4 cm², about 5 cm² or about 6 cm² to any of about 7 cm², about 8 cm², about 9 cm², about 10 cm², about 11 cm², about 12 cm², about 13 cm², about 14 cm² or about 15 cm². It may also mean observable by a CIE 1931 2° standard observer and/or by a CIE 1964 10° standard observer. The background for color observation may be any background, for instance a white background, black background or a dark background anywhere between white and black.

The term “of” may mean “comprising”, for instance “a liquid dispersion of” may be interpreted as “a liquid dispersion comprising”.

The term “non-spherical photonic structures”, etc., referred to herein may mean for example a plurality thereof, a collection thereof, a population thereof, a sample thereof or a bulk sample thereof.

The term “micro” or “micro-scaled” means from about 0.5 μm to about 999 μm. The term “nano” or “nano-scaled” means from about 1 nm to about 999 nm.

The term “monodisperse” in reference to a population of particles means particles having generally uniform shapes and generally uniform diameters. A present monodisperse population of particles for instance may have 90%, 91%, 92%, 93%, 94%, 95%, 96%, 97%, 98% or 99% of the particles by number having diameters within ±7%, ±6%, ±5%, ±4%, ±3%, ±2% or ±1% of the average diameter of the population.

Removal of a monodisperse population of polymer particles provides porous metal oxide particles having a corresponding population of pores having an average pore diameter.

The term “substantially free of other components” means for example containing ≤5%, ≤4%, ≤3%, ≤2%, ≤1% or ≤0.5% by weight of other components.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

U.S. patents, U.S. patent applications and published U.S. patent applicants discussed herein are hereby incorporated by reference.

Unless otherwise indicated, all parts and percentages are by weight. Weight percent (wt %), if not otherwise indicated, is based on an entire composition free of any volatiles, that is, based on dry solids content.

### ILLUSTRATIVE EXAMPLES

The following examples are set forth to assist in understanding the disclosed embodiments and should not be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1: Synthesis of PEG-Capped Polystyrene (PS) Colloids

The materials used in this example include: styrene (99%, Sigma-Aldrich Reagent Plus, with 4-ter-butylcatechol as stabilizer); 4-methoxyphenol (BISOMER S 20 W, GEO Specialty Chemicals); acrylic acid (Sigma-Aldrich); and ammonium persulfate (APS, OmniPur, Calbiochem).

A 500 ml three-neck round-bottom flask equipped with a water condenser, thermometer, nitrogen inlet, and magnetic stirrer was placed in an oil bath. 129 ml of deionized water (18.2 Macm) was added and purged with nitrogen through a needle inserted into the reaction mixture while stirring at 300 rpm for 15 minutes. Styrene (8.84 g, 84.8 mmol) was added under stirring and the flask was heated to 80° C. The needle delivering nitrogen was withdrawn from the reaction mixture yet left inside the flask to allow nitrogen flow through the flask for the duration of the reaction. Once the bath equilibrated at 80° C., BISOMER S 30W (895.5 mg, 7.2 mmol) was added and the mixture was stirred for 5 minutes. APS (34.0 mg, 0.1 mmol) dissolved in deionized water (1 ml) was then added to the reaction mixture over 10 seconds. The reaction was stirred for 18 hours at 80° C., yielding a white, opaque, colloid solution. Following the completion of the reaction the colloids were filtered through a Kimwipe resting on a glass funnel and introduced into a dialysis bag (Spectra/Por 12-14 kD). The dialysis bag was placed in a 1 gallon deionized water bath for 72 hours. Water was changed approximately every 24 hours. After 72 hours the purified dispersion of the colloids was transferred into a glass bottle. The size and size distribution of the colloids (244±5 nm) was measured using SEM.

### Example 2: Synthesis of Carboxylate-Capped PS Colloids

An analogous procedure to the described above with the following modifications was used for the synthesis of carboxylate capped colloids: 1 L three-neck flask, 480 ml of DI water, 48 g of styrene, 200 mg of acrylic acid (instead of BISOMER), 200 mg of APS. The procedure resulted in 320 nm colloids.

### Example 3: Synthesis of Polymethylmethacrylate (PMMA) Colloids

The materials used in this example include: ammonium persulfate (APS)—free-radical initiator; methyl methacrylate (MMA)—monomer; ethylene glycol dimethacrylate (EGDMA)—crosslinker; and 1-dodecanethiol—chain-transfer agent.

Using the same set-up as shown in (1), 200 mg of APS were added to 90 ml DI water and left to stir for at least one hour. The temperature was monitored closely to maintain a steady 90° C. throughout the reaction. In a separate vessel 10.5 ml of MMA, 189.6 pL of EGDMA, and 47.3 pL of dodecanethiol were mixed and sonicated for 5 minutes and then quickly added into the flask. The temperature of the reaction was monitored, making sure that it recovered to 90° C. The solution was stirred for 3-6 hours before being removed from heat and cooled. The product was filtered through a kimwipe into dialysis tubing and purified over 10 cycles, changing the water once a day.

This procedure resulted in 100 ml total volume of monodisperse poly(methyl methacrylate) (PMMA) colloid about 280 nm in size. Adjustments to concentrations of reactants and reaction temperature were also investigated. Temperature was found to be the most effective factor controlling the colloid size; typically 95° C. produced sizes of about 240 nm, 85° C. produced sizes of about 300 nm, 80° C. produced sizes of about 350 nm.

### Example 4: Free-Form Platelet-Like Structures (off of the side walls of the vial)

The co-assembly solution is comprised of a mixture of a silica precursor solution and polymer colloids (PMMA or PS) suspended in water. The silica precursor was prepared by combining tetraethylorthrosylicate (TEOS), ethanol, and 0.01 M HCl (1:1.5:1, v/v) and left to stir for 1 hour. 100 pl of the precursor solution was added to 20 ml water containing 0.1% colloids (w/v). Solutions were briefly sonicated (15 seconds) and then placed undisturbed in a 65° C. oven for 2-3 days, or until the liquid fully evaporated. Calcination was performed by ramping the temperature to at 500° C. for 5 hours, isothermal step for two hours, and ramp down for 4 hours. Typical yields were about 4 to 5 mg per 20 ml. Alterations in calcination conditions (temperature, ramping speeds, and oxygen-free environments) were also investigated.

### Example 5: Templated Platelet-Like Structures

Prior to photolithography microscope slides were cleaned with acid piranha (1:3 sulfuric acid: 30% hydrogen peroxide) for a minimum of 30 minutes, followed by oxygen plasma activation for 5 minutes and then dehydration at 180° C. for at least 15 min. SU-8 2015 photoresist (Microchem) was spun onto the slides and flood exposed to UV light (365 nm), to result in about 15 pm flat layer of sacrificial photoresist. After a post-exposure hardbake (95° C.), a secondary layer of SU8 2015 was deposited. After a soft (65° C.) and hard (95° C.) bake steps, slides were masked with Mylar masks (FineLine Imaging) and exposed to UV light (365 nm). After post-exposure soft and hard bake steps, slides were submerged in SU-8 developer (Microchem) until sufficiently developed. Typical development time for this thickness is about 3 min. The indication for complete development is the absence of white precipitate when the sample is rinsed with isopropanol. The procedure resulted in the formation of templates for platelet-like structure growth within channels 25 or 50 μm wide.

Prepared glass slides with SU-8 channels were cleaned via oxygen plasma for 5 min to lower the contact angle between the surface and the co-assembly solution. The samples were suspended vertically in 25 ml-slide boxes containing the co-assembly solution (described in part 4) in an oven (Memmert) at 65° C. Typical time for complete evaporation was 48 h. Slides were calcined using the same conditions mentioned above. This step served to sinter the matrix, remove the polymer colloids, and release the photonic bricks from the photoresist template. Typical yields of templated photonic bricks were 1-3 mg per slide. The presence of photoresist limited the alterations that could be made to calcination, for example in an oxygen free environment the resist did not fully combust and contaminated the final product.

### Example 6: “Bulk” Platelet-Like Structures

30 50-mI conical tubes, each containing 20 ml of polystyrene colloids (solid content as synthesized about 5 wt %), were allowed to completely dry in a 70° C. oven. The resulting “bulk” direct opals were collected and spread over an absorbent filter paper. The filter paper helps to reduce an over-layer of silica resulting from the excess of TEOS residing on the opals following infiltration. A solution of TEOS was prepared in the following manner: 1000 μl of TEOS were added to a mixture containing 800 μl of methanol and 460 μl of water followed by 130 μl of a concentrated hydrochloric acid and 260 mg of cobalt nitrate dissolved in 160 μl of water. The opals were infiltrated with this solution in three repetitive steps, allowing for one hour drying in between each infiltration, to ensure substantial filling of the structure. After the final infiltration the material (compound opal) was calcined under argon or in the presence of air, using the following conditions: 10 min ramp to 65° C., hold for 3 hours (to allow for drying and, in the case of argon, to ensure removal of all oxygen from the system), ramp for two hours up to 650° C., hold for two hours and ramp down to room temperature for two hours. After calcination the final product was ground through two consecutive metal sieves, with 140 and 90 microns pore sizes respectively using ethanol to help transfer the powder through the meshes.

### Example 7: Surface Modification of Platelet-Like Structures

Following particle size reduction and solvent evaporation platelet-like structures were left for one hour in a 130° C. oven. Then the platelet-like structures were transferred into a vacuum desiccator containing three two-ml vials with 100 pl of 1H,1H,2H,2H-tridecafiuorooctyltrichlorosilane (13F) each for 48 h. Upon completion, the powder was placed in an oven at 130° C. for 15 min.

Following particle size reduction, 13F-silane was added to the ethanol dispersion of platelet-like structures to result in 1% (v/v). The mixture was left to react for one hour. Following functionalization the platelet-like structures were rinsed thoroughly with ethanol and DI water, centrifuged in between washes and finally placed in an oven at 130° C. for 15 min. In a separate experiment this solution was left to react for 24 hours. Reaction time of one hour was insufficient (non-wetting in water but wetting in water-ethanol solutions above 50%). 24 hours reaction time resulted in the disappearance of the structural color.

Calcination of platelet-like structures in inert conditions results in the deposition of carbon black within the pores of the inverse opal particles. Presence of the carbon black reduces the surface area of the silica accessible for reaction with silanes. Initial attempts to modify the particles with 13F in the gas or liquid phase as described above showed limited degree of surface modification resulting in water and organic solvents capable of infiltration into the pores. Consequently binding of perfluoroalkane to the carbon deposit was attempted. First, the surface of the carbon black was activated by stirring about 100 mg of platelet-like structures in a mixture of sulfuric and nitric acid (3 ml and 1 ml respectively) at 70° C. for two hours. (In a separate experiment this time was extended to overnight.) This activation step was aimed to form carboxylated surface on the carbon black. Following this activation step the platelet-like structures were washed in two rounds of centrifugation (8K RPM) and redispersion in 1M HCl followed by three rounds of centrifugation and redispersion in DI water. The resulted powder was transferred into a glass vial and allowed to dry in the oven at 65° C. for 4 hours. After drying the powder was redispersed in 1 ml of dichloromethane (DCM). Then, 1 ml of DCM solution of N,N′-Dicyclohexylcarboxydiimide (DCC, 0.17 mmol) was added and the mixture was left for stirring for 30 min. After 30 min, a mixture of dimethylaminopyridine (DMAP, 5 mg) and 1,1,2,2-Tetrahydroperfluoro-dodecanol (17F-OH, 80 mg) in DCM and Novec-7500 (3M) (1:3) were added and the overall mixture was left to react for overnight at room temperature. Next, the dispersion was centrifuged at 14K RPM for two minutes and redispersed in Novec-7500. This sequence of centrifugation and redispersion was repeated with the following solvents: Novec-7500 (×2), Novec-7500:toluene (1:1, v/v, ×2), toluene (×2), toluene:DCM (1:1, v/v, ×2), DCM:methanol (1:1, v/v, ×2), and methanol (×2). Finally, the resulting powder was dried at 65° C. for overnight.

The procedure did not yield sufficient surface modification of platelet-like structures capable of preventing solvents to infiltrate the porous structure. Consequently, the procedure (a) described above was modified. It was found that longer drying time before the reaction (2 hours), fast transfer of the dried platelet-like structures into the vacuum chamber, placing a vial containing silane into the still-hot container with SHARDS, and longer reaction times (about two days) improve the efficiency. The resulted powder could be dispersed in a solvent- or water-based clear coats with no drastic change in their appearance.

### Example 8: Coating Compositions

Photonic non-spherical structures of the present invention can be formulated into a coating composition with any of the component(s) disclosed herein.

### Example 9: Procedure For Evaluating Non-Spherical Structural Colorants in a Waterborne Basecoat System

Glass vials were first loaded with pre-calculated quantity of non-spherical structural colorant samples produced as described above. Pre-calculated quantities of clear base for waterborne basecoat were then added to the vials. It was ensured that all the samples had pigment to binder ratio of 0.20. All of the samples were then mixed gently to prepare homogeneous paint samples. Thereafter, all of the paint samples were filtered with 75 micron pore size filter cloth. All of the paint samples were applied on metal panels precoated with black primer via drawdown application using a box applicator. All of the panels were then baked at 275° F. for 25 minutes in an electric oven. The film thickness of the paint layer comprising the non-spherical structural colorant (“Example”) was in the range of 16 to 18 microns. The color measurement on all of the coated panels was performed using a BYK-mac I spectrophotometer.

Coating properties can be characterized in terms of a mathematical description known as color “space,” which are defined by CIEL*a*b* values. CIEL*a*b* values include a number of different parameters. The L value is a scale of 0 to 100 that describes how light or how dark the color is. The higher the number the more light the color is (e.g., a pure bright white would be 100). The a* value defines how the hue appears on the red-green axis; the more negative the number the greener it is. Similarly, the b* scale defines the yellow-blue color, with a more positive number being more yellow. Color can also be defined using polar coordinates, where the degree of saturation, C*, indicates how vivid the color is. The further away from the origin, the more vivid the color. The hue angle, h, is a representation of the actual hue of the color. Specular reflection (the mirror like reflection) is assigned a value of zero angle. The color is also quantified at 15, 25, 45, 75, and 110 degrees away from the specular reflection. The 15 and 25 degree angles are often referred to as the “face” or “flash” angles, whereas the 75 and 110 degrees are called the “flop” angles.

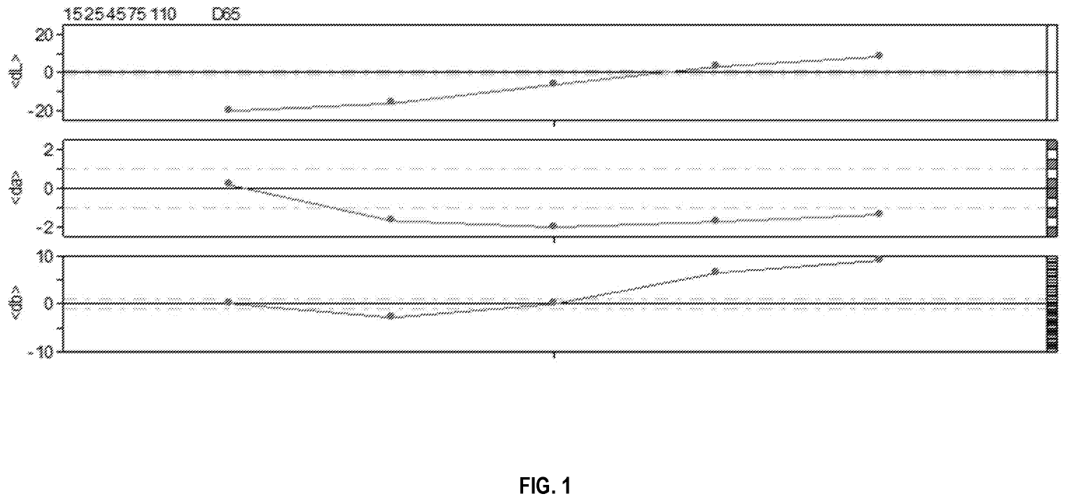

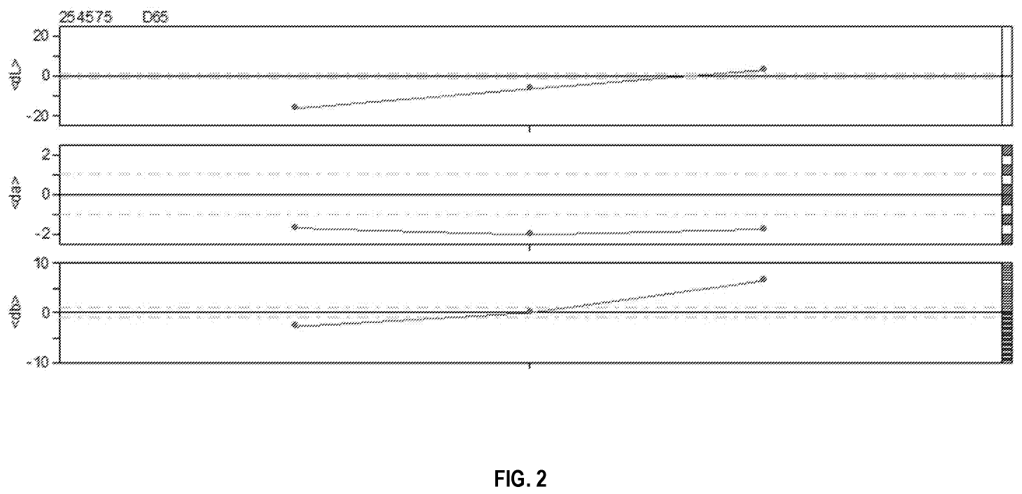

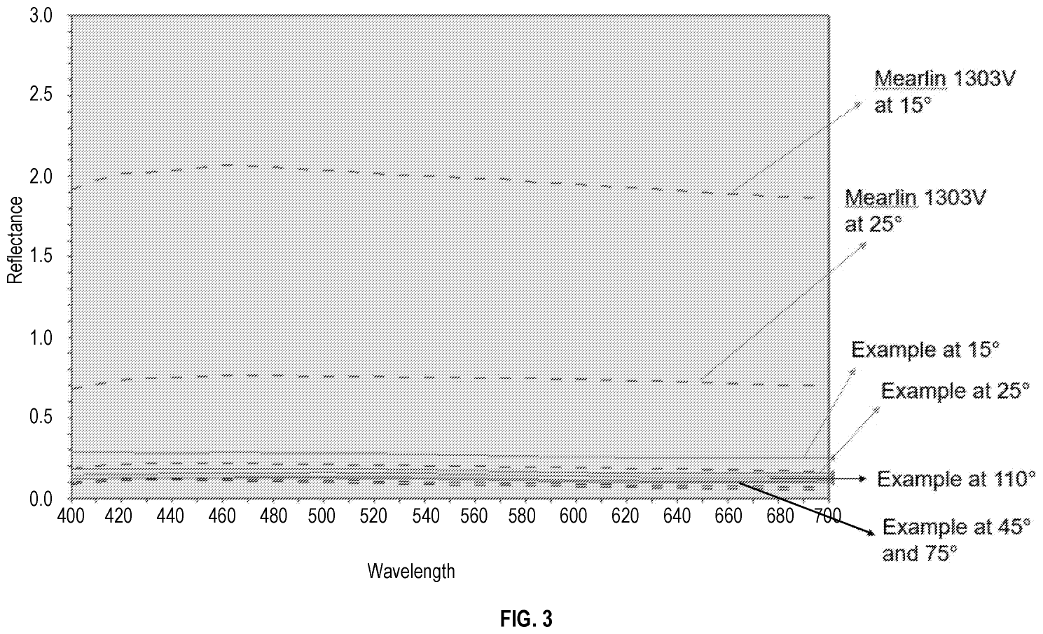

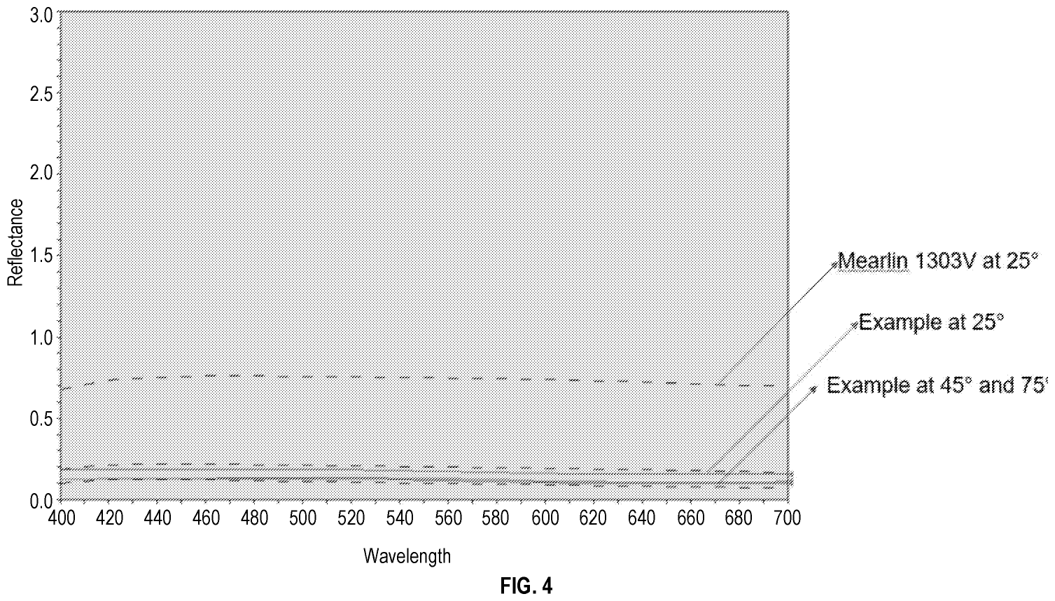

FIGS. 1 and 2 show a comparison of coloristic properties of the Example coating with a control (Ext. Mearlin® 1303V white mica) for 5 angles and 3 angles, respectively. The Example exhibited a darker appearance at face and flash angles, while appearing lighter at the flop angles. The Example further appears greener and yellower than the control, demonstrating a unique color position. FIGS. 3 and 4 show corresponding reflectance curves at 5 angles and 3 angles, respectively, corresponding to the Example and control samples.

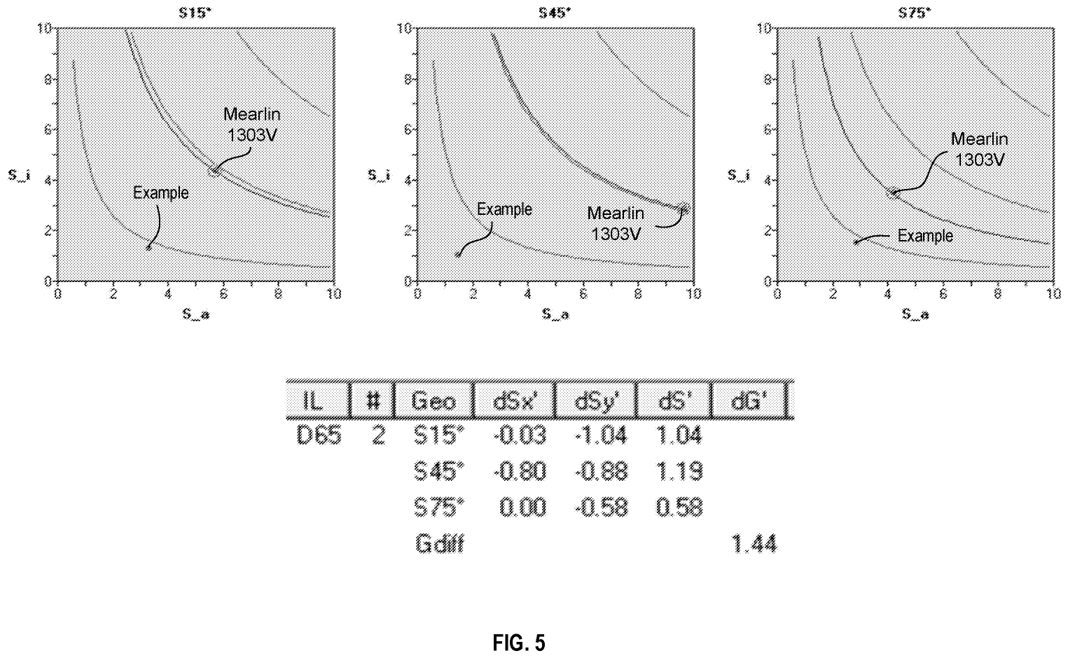

FIG. 5 shows sparkle area and intensity data for three angles for the Example and control, indicating lower sparkle area and intensity for the Example compared to the control.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment, and such references mean “at least one”.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1-39. (canceled)

40. A coating composition comprising:
a solvent;
a resinous binder; and
a structural colorant comprising non-spherical photonic structures.

41. The coating composition of claim 40, wherein the non-spherical photonic structures are direct photonic non-spheres or inverse photonic non-spheres, and wherein the structural colorant exhibits angle-dependent iridescence or angle independent color.

42. The coating composition of claim 40, wherein the ratio of structural colorant to resinous binder is about 1:100 to about 50:100.

43. The coating composition of claim 40, wherein the structural colorant comprises a metal oxide selected from the group consisting of silica, titania, alumina, zirconia, ceria, iron oxides, zinc oxide, indium oxide, tin oxide, chromium oxide and combinations thereof, preferably selected from the group consisting of silica, titania, and combinations thereof.

44. The coating composition of claim 40, wherein the structural colorant comprises non-spherical photonic structures having an average diameter of from about 1 μm to about 75 μm, and an average pore diameter of from about 50 nm to about 800 nm, and an average porosity of from about 0.45 to about 0.65.

45. The coating composition of claim 40, wherein at least a portion of an external surface of the structural colorant comprises silane functional groups.

46. The coating composition of claim 40, wherein the structural colorant comprises transition metal ions.

47. The coating composition of claim 40, wherein the structural colorant comprises carbon black.

48. The coating composition of claim 40, having a Zeta Potential (mV) of from about 5 to about 20; from about 8 to about 18; or about 10 to about 15, and an intensity of from about 0 to about −100; from about −10 to about −50; about −15 to about −45; or about −40.

49. A coating derived from the composition of claim 40.

50. A coating comprising a colorant layer comprising:
a resinous binder; and
a structural colorant comprising non-spherical photonic structures.

51. The coating of claim 50, wherein the coating comprises a ground coat, and wherein the colorant layer is layered over the ground coat.

52. The coating of claim 50, wherein the coating further comprises a clear coat layer, wherein the clear coat is layered over the colorant layer.

53. The coating of claim 50, further comprising one or more additional layers:
between a ground layer and the colorant layer; between the colorant layer and a clear coat layer;
over the clear coat layer; under a ground layer; or a combination thereof.

54. An article of manufacture comprising a substrate and the coating of claim 50, wherein the substrate is an automotive part.

55. A method of preparing a coating composition comprising:
mixing a solvent, a resinous binder, and a structural colorant comprising non-spherical photonic structures to obtain the coating composition of claim 40.

56. A method of coating a substrate comprising layering the coating composition of claim 40 onto a substrate, the method further comprising selecting dimensions of the structural colorant to achieve a pre-determined color standard, wherein the color standard has been previously attained by the structural colorant, wherein the dimensions are optionally one or more of diameter, pore diameter and porosity.

57. The method of claim 56, wherein the substrate is an automotive part, wherein the automotive part is optionally an external panel or an interior part.

58. The method of claim 56, wherein the color of the color standard has a wavelength of 380-450, and wherein the color of the layered substrate is the same or substantially the same as the standard based on spectrophotometry measurement.

59. The method of claim 56, wherein the structural colorant comprises crystals, photonic granules, opals, inverse opals, folded photonic structures, or platelet-like photonic structures.
